(19) United States
(12) Patent Application Publication
(10) Pub. No.: US 2003/0088484 A1
(43) Pub. Date: May 8, 2003

(54) Website service method

(76) Inventors: Fong-Yuan Chang, Taichung Hsien (TW); Ing-Kai Huang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/985,704

(22) Filed: Nov. 6, 2001

(51) Int. Cl. G06F 17/60

(52) U.S. Cl. 705/27

(57) ABSTRACT

The present invention provides a website service method. First, a specific demand event to be searched is set at one's own server, and several website addresses, BBS addresses, or related server addresses are inputted. A searching program then actively collects related data, and stores the data into a database. Next, the server picks out communication information and mating data and then actively invites the supplier and the demander to enter the website. After the supplier and the demander are informed, they can connect to the website to register and input article data or demand conditions. The website performs relational mating of supply and demand and then displays the mating result. If the requirements of the supplier and the demander are met, they can contact each other through data provided by the database. Supply and demand can thus be more effectively and quickly accomplished.

### FIELD OF THE INVENTION

The present invention relates to a website service method and, more particularly, to a service method of letting one's own server, by means of searching data on the Internet, actively invite suppliers and demanders to connect to the service website for performing higher-level relational mating of supply and demand.

### BACKGROUND OF THE INVENTION

Today, Internet has been well known and extensively used. People can search plentiful information from the Internet, and can register data to WWW, BBS, NEWS, or Gopher themselves. There are many web pages and boards about house rental, jobs, tutors, and business transactions. However, these data are generally distributed everywhere. Suppliers and demanders thus can only search data in some more famous websites, or resort to some searching engines. Therefore, much time is wasted, and the searched data need to be sifted with the possibility that the required result is not obtained.

Accordingly, specific service websites come into being. It is only necessary for a user to input some condition items to let a service website perform mating to search appropriate data. In addition to being provided by the website itself, the source of data are mostly registered by other users and then stored into a database of the website. Therefore, the more contents the database has, the better mating the suppliers and demanders can obtain.

The present invention thus aims to resolve the important issue of how to increase the number of people browsing the website. The specific service websites usually utilize multiple ways of marketing and advertisement such as publishing on newspapers and media or renting advertisement frames of web pages to come into notice, with the hope of attracting more people to connect to the websites. The expense is usually very high, but corresponding effect cannot be assured.

Accordingly, the present invention aims to propose a website service method to resolve the above problems.

### SUMMARY OF THE INVENTION

The primary object of the present invention is to provide a website service method, whereby a searching program of one's own server can actively search contents of specific web pages, boards, or related servers to collect related demand information.

The secondary object of the present invention is to provide a website service method capable of analyzing the information to pick out relational and mating data, and then actively informing suppliers and demanders of the address and service items of the service website.

Another object of the present invention is to provide a website service method, whereby suppliers or demanders can enter the website to register data and look up related data of supply and demand.

Yet another object of the present invention is to provide a website service method capable of periodically sending related information to suppliers or demanders.

To achieve the above objects, the present invention mainly provides a website service method, wherein specific demand events to be searched are set at one's own server, and addresses of one or more websites, BBS, or related servers are inputted. A searching program of the server then actively collects related data, stores the data into a database, analyzes the data, and picks out valid e-mail addresses. E-mails are mailed via an email server to inform a supplier and a demander of the address and service items of the website. After the supplier and demander are informed of these information, they can connect to the website, and input article data or demand conditions to be mated relationally by the website. The mating results are then displayed. When requirements of both the supplier and demander are met, the website can contact them through the data provided by the database to accomplish supply and demand. The website then deletes this piece of article data and/or demand condition.

The various objects and advantages of the present invention will be more readily understood from the following detailed description when read in conjunction with the appended drawings, in which:

### BRIEF DESCRIPTION OF THE DRAWINGS

FIG. 1 is an architecture diagram of network interconnection of the present invention;

FIG. 2 is a flowchart of searching, analyzing, and mailing email of the present invention;

FIG. 3 is an operational flowchart of a service website of the present invention;

FIG. 4 is a web page register frame of a house rental website according to an embodiment of the present invention;

FIG. 5 is a web page frame advertising a house to be rented of a house rental website according to an embodiment of the present invention; and

FIG. 6 is a web page frame of inquiry result of a house rental website according to an embodiment of the present invention.

### DETAILED DESCRIPTION OF THE PREFERRED EMBODIMENTS

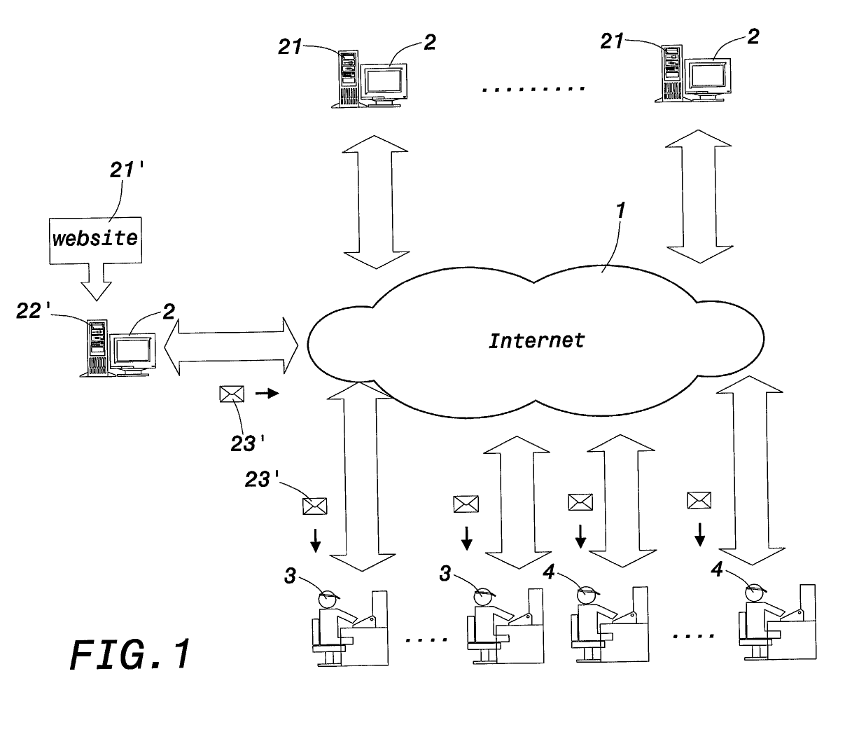

FIG. 1 shows an interconnection architecture of the Internet 1 with several servers 2 are distributed. A database 21 of each of the servers 2 has plentiful inbuilt network resources such as WWW, BBS, NEWS, and Gopher so that many suppliers 3 and demanders 4 can connect to the network from their own host computers to search appropriate data or actively broadcast information to the Internet 1.

In the website service method of the present invention, a service website 21′ is installed at one's own server 2′ in the existent architecture of the Internet 1. The service website 21′ is a web-based platform with web page format of HTML. Therefore, the service website 21′ can conform to all information on the Internet. In addition to information provided by itself, the suppliers 3 or the demanders 4 can register data themselves to be stored into a database 22′ of the server 2′. The service website 21′ also has the function of mating supply and demand.

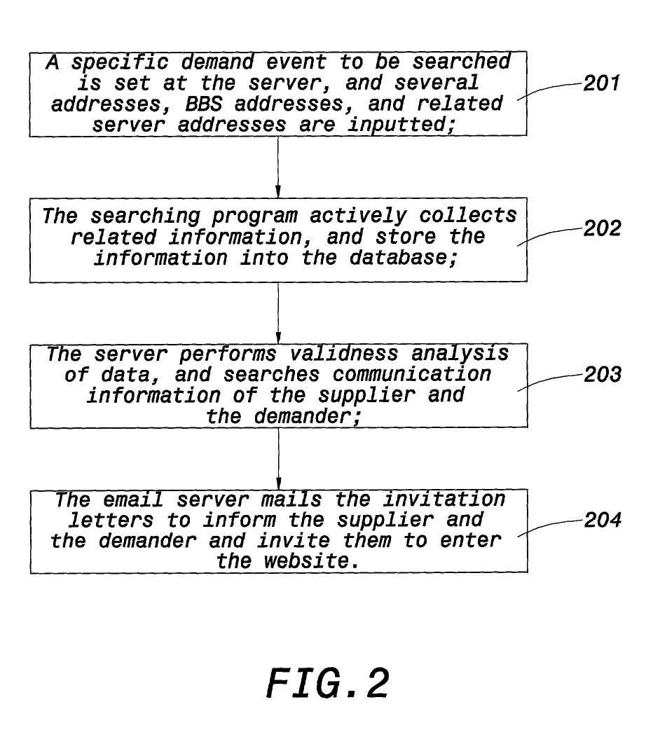

Because the Internet 1 penetrates everywhere, and connection speeds become faster and faster in the current wideband age, a large number of people are attracted to connect to the Internet 2. In order to let suppliers 3 and demanders 4 having registered data of supply or demand on the Internet 1 know the existence and service of the website 21′, the server 2′ provides a searching program (not shown) to collect large quantity of data, store the data into the database 22′, and analyze the data. An email server (not shown) in the server 2′ then mails invitation letters 23′ to them. The operational flowchart is shown in FIG. 2, which comprises the following steps.

Step 201: A website supervisor sets a specific demand event to be searched at the server 2′, and inputs addresses of several related WWW, BBS, or other servers (e.g., News, Gopher, and so on) on the Internet 1. The addresses can be appended afterwards (periodically or aperiodically);

Step 202: After inputting, the searching program actively collects related information (periodically or aperiodically), and store the information into the database 22′;

Step 203: The server 2′ performs validness analysis of data, and searches communication information of suppliers and demanders such as email addresses (strings including “@” and “.”);

Step 204: The email server mails the invitation letters 23′ to inform the supplier 3 and/or the demander 4 of the address and service items of the website 21′.

Moreover, in addition to using the email server to mail the invitation letters 23′, the present invention can also inform the supplier and/or the demander via voicemail or fax.

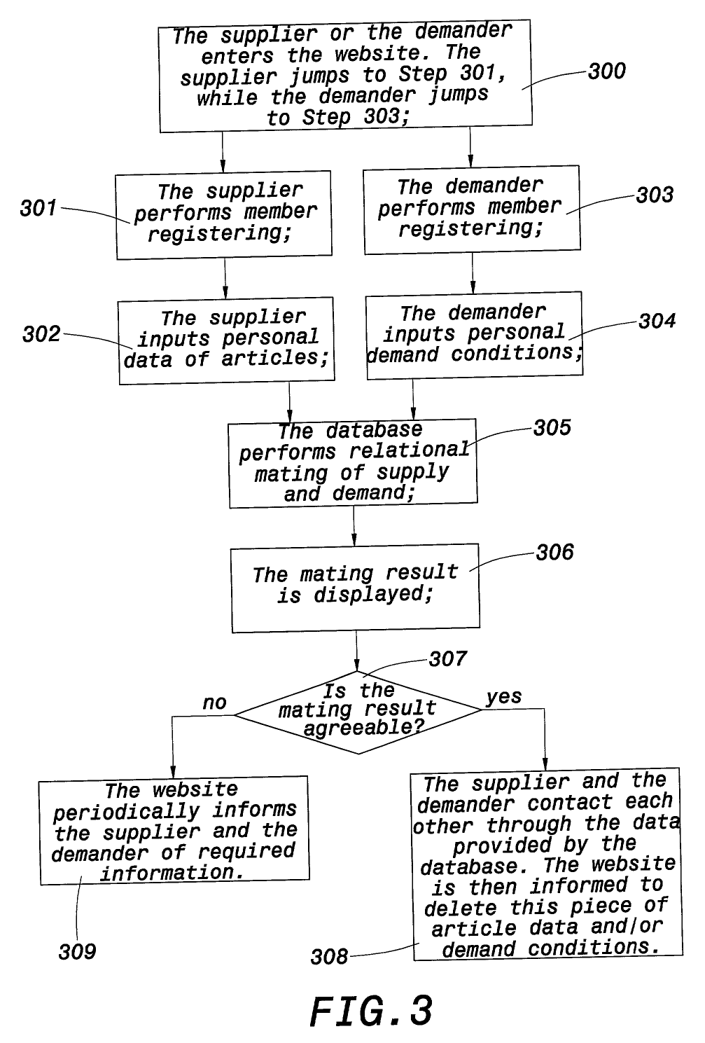

As shown in FIG. 3, after the supplier 3 and the demander 4 receive the emails, they can connect to the website 21′ to perform services such as member registering, data recording, inquiry, and mating. The operational flowchart comprises the following steps.

Step 300: After entering the website 21′, the supplier 3 jumps to Step 301 to perform functional items of supplier, while the demander 4 jumps to Step 303 to perform functional items of demander;

Step 301: The supplier 3 performs member registering (e.g., inputting username, password, basic data, and so on);

Step 302: The supplier 3 inputs data of several articles, and then jumps to Step 305;

Step 303: The demander 4 performs member registering (e.g., inputting username, password, basic data, and so on);

Step 304: The demander 4 inputs several demand conditions;

Step 305: The database 22′ starts to perform relational mating of supply and demand;

Step 306: The mating result is displayed;

Step 307: Step 308 is jumped to if the result is agreeable; Step 309 is jumped to otherwise;

Step 308: The supplier 3 and the demander 4 can contact with each other through the data provided by the database 22′ to accomplish supply and demand. The website 21′ is then informed to delete this piece of article data and/or demand conditions. This flowchart is thus ended.

Step 309: The website 21′ periodically informs the supplier 3 and the demander 4 of required information.

The present invention will be illustrated below with a house rental website according to a preferred embodiment of the present invention as an example. First, the website supervisor sets the server 2′ to search websites, BBS, or other servers having related house rental information. The searching program then collects related information on the Internet 1, and stores the information into the database 22′. Next, the server 2′ analyzes valid house rental data and communication information of supplier and demander such as email addresses. The lesser is the supplier 3 in the figure, and the lodger is the demander 4 in the figure. Subsequently, the server 2′ actively informs the lesser and lodger of the address and house rental service of the website 21′, e.g., mailing invitation letters 23′ via the email server.

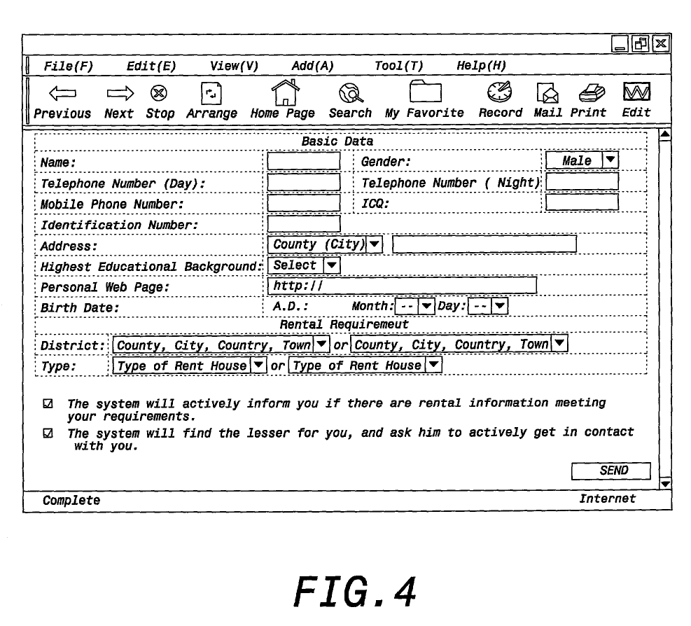

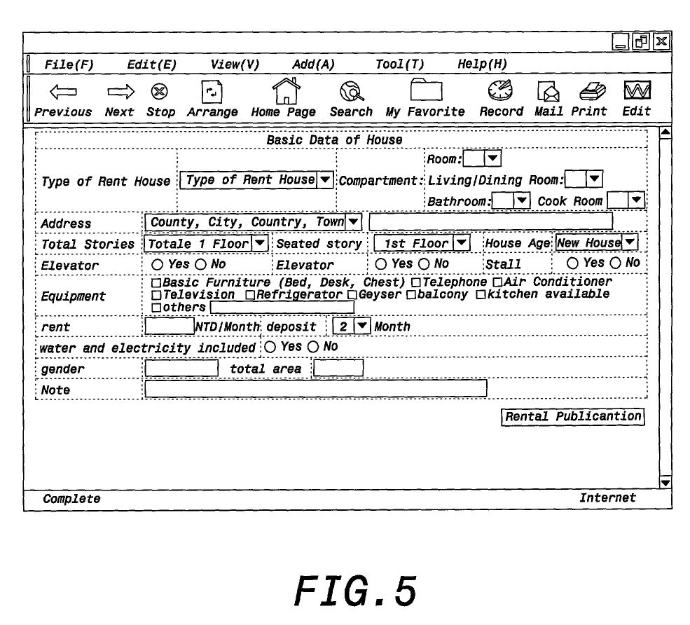

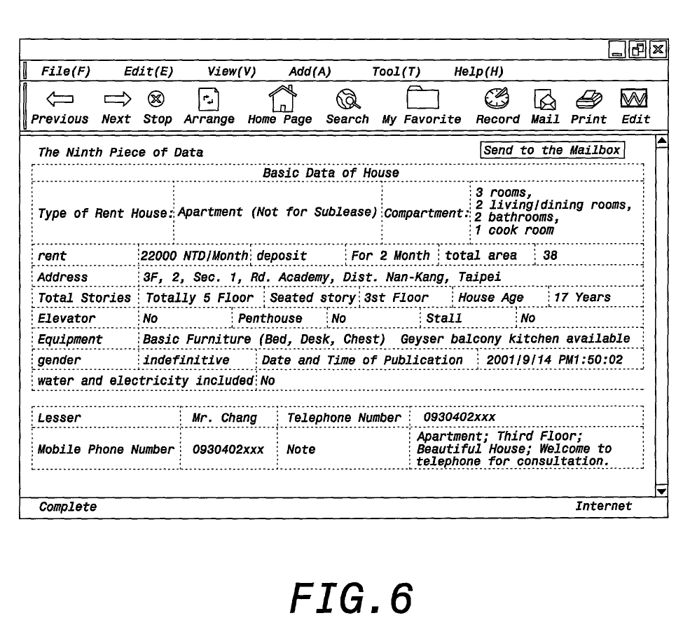

After the supplier 3 and the demander 4 receive the invitation letters 23′, they can connect to the website 21′ to register as member (shown in FIG. 4), run rental advertisement (shown in FIG. 5), or makes choices of rental demand (the frame is similar to that shown in FIG. 5). After confirmed, the database 22′ makes relational mating of supply and demand. The lesser can thus know a customer 41 wanting to rent a house from the inquiry result, and he can contact the customer 41 through the lodger data provided by the website 21′ (shown in FIG. 6). The lodger can also know a lesser having a house for rental from the inquiry result, and he can contact the lesser (the frame is similar to that shown in FIG. 6). After the deal is accomplished, the website 21′ is informed to delete this piece of rental advertisement and/or rental demand. Additionally, if the mating result is not satisfactory, the website 21′ will periodically (or aperiodically) informs the lesser and the lodger of required house rental information by means of sending electronic newspapers, invitation letters, ICQ messages, voicemails, or faxes.

Thereby, the lesser can quickly rent a house to an appropriate lodger, avoiding needless waste and money loss. The lodger can also quickly rent an appropriate house for usage as office, storefront, or residence.

To sum up, the present invention has the following characteristics.

1. Existent data of supply and demand can be effectively picked out from the Internet.

2. The supplier and the demander can be informed of the website by means of active invitation.

3. The supplier and the demander can connect to the website to register or inquire data so that faster and more effective mating can be obtained.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A website service method comprising the steps of:
(a) setting a specific demand event to be searched at one's own server, and inputting one or more website addresses or BBS addresses;
(b) a searching program of said server actively collecting related data and storing the data into a database;
(c) said server analyzing the data and picking out communication information of supplier and demander;
(d) actively informing the supplier and the demander of the address and service items of said website to invite them to enter said website;
(e) the supplier and the demander connecting to the Internet to enter said website after being informed;
(f) the supplier and the demander performing registering, and inputting article data or demand conditions;
(g) said website performing relational mating of supply and demand and displaying the mating result; and
(h) the supplier and the demander contacting each other through data provided by said database to accomplish supply and demand when their requirements are met, and said website being informed to delete this piece of article data and/or demand conditions.

2. The website service method as claimed in claim 1, wherein said website addresses in said Step (a) can be WWW addresses or related server addresses.

3. The website service method as claimed in claim 1, wherein said website addresses or said BBS addresses can be appended.

4. The website service method as claimed in claim 1, wherein the communication information in said Step (c) can be email addresses, telephone numbers, or fax data.

5. The website service method as claimed in claim 1, wherein the way of actively informing the supplier and the demander in said Step (d) can be sending emails via an email server, or informing via voicemail or fax.

6. The website service method as claimed in claim 1, wherein if the requirements of the supplier and the demander are not met in said Step (h), said website will send electronic newspapers, emails, ICQ messages, voicemails, or faxes to inform the supplier and the demander of required information.
